(19) United States
(12) Patent Application Publication
(10) Pub. No.: US 2003/0091243 A1
(43) Pub. Date: May 15, 2003

(54) Periodical pattern suppression processing method and apparatus

(75) Inventor: Ryoji Sasada, Kaisei-machi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/293,438

(22) Filed: Nov. 14, 2002

(30) Foreign Application Priority Data
Nov. 14, 2001 (JP) 348333/2001

(51) Int. Cl. G06K 9/40; G06K 9/00; G06T 5/00

(52) U.S. Cl. 382/260; 382/275; 382/132

(57) ABSTRACT

A method and apparatus for periodical pattern suppression processing capable of suppressing the spatial frequency component of periodical patterns occurring in image signals without deteriorating the image quality thereof, and achieving these results in a reduced processing time. The spatial frequency component corresponding to a periodical pattern included in an image signal is extracted from the image signal by subjecting the image signal to a one-dimensional filtering process in the same direction as that of the periodical pattern and in the direction perpendicular to that of the grid image. By subtracting the extracted spatial frequency component from the image signal, the spatial frequency component occurring in the image signal is suppressed.

### BACKGROUND OF THE INVENTION

1. Field of the Invention

The present invention relates to a periodical pattern suppression processing method and apparatus for suppressing the spatial frequency component corresponding to the periodical patterns occurring in image signals.

2. Description of the Related Art

There are in wide use today for Computed Radiography (CR), radiation image readout apparatuses that utilize stimulable phosphors (storable phosphors) in sheets comprising a layer of stimulable phosphors formed on a substrate, which upon the irradiation thereof with radiation (x-rays, αrays, βrays, γrays, an electron beam, ultraviolet rays, or the like) store a portion of the radiation energy thereof, and emit a stimulated emission corresponding to the radiation energy stored therein upon the subsequent irradiation thereof with a visible light, a laser light or other excitation light. Stimulable phosphor sheets are widely used in conjunction with CR systems, wherein: the radiation-image data of a human body or other subject of photographing through which radiation has been passed is temporarily stored on a stimulable phosphor sheet; said stimulated phosphor sheet is scanned with a laser or other excitation light causing a stimulated emission to be emitted therefrom; and said stimulated emission is photoelectrically converted to obtain an image signal.

When a radiation image of a target subject is to be recorded on the above-described stimulable phosphor sheet or the like, there are cases in which stationary grids, which are of a fine pitch comprising approximately four grid elements per mm in which a material such as lead which does not transmit radiation or a material such as aluminum which readily transmits radiation, are alternately disposed, so as to prevent the irradiation of the sheet by radiation dispersed by the target subject, between the target subject and the sheet to obtain the radiation image. Because it becomes difficult for the radiation dispersed by the target subject to irradiate the sheet when the image obtainment is performed utilizing the stationary grids, the contrast of the radiation image of the target subject can be improved. However, an image of a fine, striped pattern grid corresponding to the grids is also recorded along with that of the target subject.

Therefore, there has been proposed, as described for example in Japanese Unexamined Patent Publication No. 2000-003440, a method of obtaining an easy to observe image in which the striped pattern image has been reduced by use of a filtering process that eliminates the spatial frequency component corresponding to the striped pattern of the stationary grids. According to this method, in a case, for example, in which the lattice distribution pitch of the of the grid (hereinafter referred to as the grid pitch) is four elements per mm, because the striped pattern appears in the spatial frequency band near 4.0 cycles/mm, a filtering process of eliminating or reducing the response of this spatial frequency band is performed so as to erase the image of the striped pattern structure.

However, regarding the filtering process described above, not only the response of the frequency component near the spatial frequency corresponding to the grid pitch of the stationary grids, but also that of other high frequency components is eliminated, whereby the high frequency components contained in the original image are suppressed or eliminated, bringing about a reduction in the sharpness of the obtained image. Accordingly, there has further been proposed, as described in U.S. Unexamined Patent Publication No. 20010012407, a method of converting the image signal by the subjection thereof to a Fourier transform or a wavelet transform to obtain a converted image signal capable of being managed within a certain frequency range, and reducing the image signal within a desired frequency range including the spatial frequency component corresponding to a periodical pattern so as to avert the aforementioned degradation in sharpness.

However, for cases in which the image signal has been subjected to a Fourier transform, the processing time becomes long; further, in the case of the wavelet transform, because the image signal is subjected to a reduction process during the course of the performance of the wavelet transform, feedback distortion occurs, giving rise to a fear that the image quality will be deteriorated.

### SUMMARY OF THE INVENTION

The present invention has been developed in consideration of problems such as those described above, and it is an object of the present invention to provide a periodical pattern suppression processing method and apparatus capable of suppressing the periodical patterns occurring in an image signal without deteriorating the image quality thereof, and achieving these results in a reduced processing time.

The first periodical pattern suppression processing method according to the present invention is a periodical pattern suppression processing method of suppressing the spatial frequency component corresponding to a periodical pattern occurring in an image signal, comprising the steps of: extracting from the image signal the spatial frequency component corresponding to a periodical pattern included therein by subjecting the image signal to a one-dimensional filtering process in the same direction as that of the periodical pattern and in the direction perpendicular to that of the periodical pattern; and suppressing the spatial frequency component occurring in the image signal by subtracting from the image signal said extracted spatial frequency component.

Here, “periodical pattern” refers broadly to periodical patterns appearing within image signals, e.g. the striped pattern caused by the stationary grids (resulting not only from the stationary grids themselves, but also including moiré components generated by the stationary grids due to sampling performed at a cycle below that of the Nyquist frequency, or due to the performance of a reduction process or the like), the moiré images produced in an image obtained by a televisual image obtaining system, and various other patterns.

Further, the referents of “one-dimensional filtering process” include filtering process utilizing a one-dimensional low pass filter, a one-dimensional high pass filter, or a one-dimensional band pass filter or the like.

Still further, “the same direction” refers to a direction which is substantially the same; “perpendicular direction” refers to a direction which is substantially perpendicular.

In addition, according to the first periodical pattern suppression processing method, the extraction of the spatial frequency component corresponding to a periodical pattern can be performed by: forming a first processed signal, of which the image signal component including the spatial frequency component corresponding to a periodical pattern is reduced, by subjecting the image signal to one type of one-dimensional filtering process; forming a second processed signal by subtracting the first processed signal from the image signal; and subjecting the second processed signal to the other type of one-dimensional filtering process.

Here, “the first processed signal” refers to, e.g. a signal having the low frequency component of an image signal of which the response of the spatial frequency component corresponding to a periodical pattern and the high frequency components of a frequency higher than or equal to that of the spatial frequency component have been caused to be substantially zero by subjecting the image signal to a one-dimensional low pass filtering process in the direction perpendicular to the periodical pattern. Therefore, at this time, “the second processed signal” refers to the signal having the high frequency component and the spatial frequency component corresponding to the periodical pattern of the image signal, from which the first processed signal has been subtracted; by subjecting this signal to a one-dimensional high pass filtering process, the spatial frequency component corresponding to the periodical pattern can be extracted.

Further, according to the first periodical pattern suppression processing method, the extraction of the spatial frequency component corresponding to a periodical pattern can be performed by: forming a first processed signal, which includes the spatial frequency component corresponding to a periodical pattern, by subjecting the image signal to one type of one-dimensional filtering process; and subjecting the first processed signal to the other type of one-dimensional filtering process.

Here, “the first processed signal” refers to, e.g. a signal having the high frequency component and the spatial component, which corresponds to a periodical pattern, of an image signal of which the response of the high frequency component of a frequency higher than or equal to that of the spatial frequency component corresponding to the periodical pattern has been caused to be a value of one by subjecting the image signal to a one-dimensional high pass filtering process in the direction perpendicular to the periodical pattern. Then, by subjecting this signal to a one-dimensional low pass filtering process in the same direction as that of the periodical pattern, the spatial frequency component corresponding to the periodical pattern can be extracted.

The second periodical pattern suppression processing method according to the present invention is a periodical pattern suppression processing method of suppressing the spatial frequency component corresponding to a periodical pattern occurring in an image signal, comprising the steps of: extracting from the image signal the spatial frequency component corresponding to a periodical pattern included therein by subjecting the image signal to a process including either of a one-dimensional filtering process performed in the same direction as that of the periodical pattern or a one-dimensional filtering process performed in the direction perpendicular to that of the periodical pattern; forming, based on the thus processed image signal component, a first processed signal of which the spatial component corresponding to the periodical pattern has been reduced; subjecting the image signal to a process including the other one-dimensional filtering process and forming, based on the thus processed image signal component, a second processed signal of which the spatial frequency component corresponding to the periodical pattern has been reduced and which has a spatial frequency component different from that of the first processed signal; and suppressing the spatial frequency component corresponding to the periodical pattern occurring in the image signal by adding the first and second processed signals.

Here, the referents of “subjecting the image signal to a process including either of a one-dimensional filtering process in the same direction as that of the periodical pattern or in the direction perpendicular to that of the periodical pattern” can include subjection of the image signal to a process including at least one of either of the two one-dimensional filtering processes, the other of either of the two one-dimensional filtering processes or a combination of the two one-dimensional filtering processes.

Further, the referents of “a process including the other one-dimensional filtering process” can include the subjection of the image signal to a process including at least the other of the one-dimensional filtering processes, and including only the other of the two one-dimensional filtering processes or a combination thereof.

Still further, according to the second periodical pattern suppression process described above, the formation of the second processed signal can be performed by subtracting from the image signal the first processed signal, which has been formed by utilizing either of a one-dimensional filtering process in the same direction as that of a periodical pattern present in the image signal or a one-dimensional filtering process perpendicular thereto, and subjecting the resultant image signal component to the other one-dimensional filtering process.

Here, “the first processed signal” refers to, e.g. a signal having the low frequency component of an image signal of which the response of the spatial frequency component corresponding to a periodical pattern and the high frequency components of a frequency higher than or equal to the spatial frequency component have been caused to be substantially zero by subjecting the image signal to a one-dimensional low pass filtering process in the direction perpendicular to the periodical pattern. Therefore, at this time, “the second processed signal” refers to the signal having the high frequency components of the image signal, and is formed by subjecting the image signal component resulting from the subtraction of the first processed signal from the image signal, that is, the signal having the high frequency component and the spatial frequency component corresponding to the periodical pattern, to a one-dimensional high pass filtering process.

In addition, with regard to the second periodical pattern suppression processing method, the first processed signal may be formed by subtracting an image signal component formed by employing either a one-dimensional filtering process in one direction, or a one-dimensional filtering process in a direction perpendicular thereto, from the image signal.

Here, “the first processed signal” refers to a signal resulting from the subtraction of an image signal component from the image signal. The image signal component has a high spatial frequency component corresponding to the periodical pattern, wherein the response of the high frequency component is made to be 1 by the administration of a one-dimensional high pass filtering process in the direction perpendicular to that of the periodical pattern, and a high frequency component, of a higher frequency than that of the high spatial frequency component. That is, “the first processed signal” is a signal having the low frequency component of the image signal. At this time, “the second processed signal” refers to a signal having the high frequency component of the image signal, formed by administering a one-dimensional high pass filtering process in the direction of the periodical pattern on the image signal component.

Further, according to the first and the second periodical pattern suppression processing methods, a detection process can be performed to detect the presence of the spatial frequency component corresponding to a periodical pattern in an image signal, and the above-described suppression processing performed only when a positive result is obtained by the detection process.

Still further, the direction of a periodical pattern occurring in an image signal can be discerned, and the direction of the one-dimensional filtering process set based upon the discerned direction.

The first periodical pattern suppression processing apparatus of the present invention is a periodical pattern suppression processing apparatus for suppressing the spatial frequency component corresponding to a periodical pattern occurring in an image signal; comprising: a first one-dimensional filtering process means for subjecting the image signal to a one-dimensional filtering process in the same direction as that of the periodical pattern; a second one-dimensional filtering process means for subjecting the image signal to a one-dimensional filtering process in the direction perpendicular to that of the periodical pattern; and a subtraction processing means for subtracting from the image signal the spatial frequency component, which corresponds to the periodical pattern, extracted by the one-dimensional filtering processes of the first and second one-dimensional filtering process means.

The second periodical pattern suppression processing apparatus is a periodical pattern suppression processing apparatus for suppressing the spatial frequency component corresponding to a periodical pattern occurring in an image signal; comprising: a first one-dimensional filtering process means for subjecting the image signal to a one-dimensional filtering process in the same direction as that of the periodical pattern; a second one-dimensional filtering process means for subjecting the image signal to a one-dimensional filtering process in the direction perpendicular to that of the periodical pattern; and an addition processing means for adding a first processed signal based on the image signal component obtained by the subjection of the image signal to a process including the one-dimensional filtering process of either the first or the second one-dimensional filtering process means and of which the spatial frequency component corresponding to the periodical pattern has been reduced, and a second processed signal based on the image signal component obtained by the subjection of the image signal to a process including the one-dimensional filtering process of the other of the one-dimensional filtering process means, which has a spatial frequency component different from that of the first processed signal and of which the spatial frequency component corresponding to the periodical pattern has been reduced.

Further, a periodical pattern detecting means for detecting the spatial frequency component corresponding to a periodical pattern occurring within an image signal can be provided.

Still further, a direction recognition means for discerning the direction of a periodical pattern occurring in an image signal, and a filtering direction setting means for setting, based on the direction discerned by the direction recognition means, the direction of the one-dimensional filtering process, can be provided.

According to the first periodical pattern suppression processing method and apparatus of the present invention: the spatial frequency component corresponding to a periodical pattern occurring in an image signal is extracted from the image signal by subjecting the image signal to a one-dimensional filtering process in the same direction as that of the periodical pattern and a one-dimensional filtering process in the direction perpendicular to that of the periodical pattern; and the spatial frequency component of the image signal is suppressed by subtracting from the image signal said extracted spatial frequency component; whereby it is possible to avoid deterioration of the sharpness of the image caused by signal loss due to the filtering process and a reduction in processing time can also be expected.

According to the second periodical pattern suppression processing method and apparatus of the present invention: the image signal is subjected to a process including either of a one-dimensional filtering process in the same direction as that of the periodical pattern or a one-dimensional filtering process in the direction perpendicular to that of the periodical pattern; a first processed signal of which the spatial component corresponding to the periodical pattern has been reduced is formed based on the thus processed image signal component; the image signal is subjected to a process including the other one-dimensional filtering process and a second processed signal having a spatial frequency component different from that of the first processed signal of which the spatial frequency component corresponding to the periodical pattern has been reduced is formed based on the thus processed image signal component; and the spatial frequency component corresponding to the periodical pattern occurring in the image signal is suppressed by adding the first and second processed signals; whereby it is possible to avoid deterioration of the sharpness of the image caused by signal loss due to the filtering process and a reduction in processing time can also be expected, as in the case of the above described first periodical pattern suppression processing method and apparatus.

### BRIEF DESCRIPTION OF THE DRAWINGS

FIG. 1 shows the main part of a radiation image readout apparatus,

FIG. 2 shows a radiation image that has been obtained by use of a grid image obtaining method,

FIG. 3 is a perspective view of an example of a radiation image readout apparatus,

FIG. 4 shows the relationship between the scanning direction and a readout image,

FIG. 5 is a schematic drawing of the main part of the first embodiment of the periodical pattern suppression processing apparatus according to the present invention,

FIG. 6 is a graph showing the properties of the low pass filter of the first one-dimensional filtering process means of the periodical pattern suppression processing apparatus shown in FIG. 5,

FIG. 7 is a graph showing the properties of the high pass filter of the second one-dimensional filtering process means of the periodical pattern suppression processing apparatus shown in FIG. 5,

FIG. 8 is a schematic drawing of the main part of the second embodiment of the periodical pattern suppression processing apparatus according to the present invention,

FIG. 9 is a graph showing the properties of the low pass filter of the second one-dimensional filtering process means of the periodical pattern suppression processing apparatus shown in FIG. 8,

FIG. 10 is a schematic drawing of the main part of the third embodiment of the periodical pattern suppression processing apparatus according to the present invention,

FIG. 11 is a graph showing the properties of the high pass filter of the first one-dimensional filtering process means of the periodical pattern suppression processing apparatus shown in FIG. 10,

FIG. 12 is a schematic drawing of the main part of the fourth embodiment of the periodical pattern suppression processing apparatus according to the present invention,

FIG. 13 is a schematic drawing of the main part of another embodiment of the periodical pattern suppression processing apparatus according to the present invention,

FIG. 14 is a schematic drawing of the main part of yet another embodiment of the periodical pattern suppression processing apparatus according to the present invention,

FIG. 15 is a schematic drawing of the main part of still yet another embodiment of the periodical pattern suppression processing apparatus according to the present invention,

FIG. 16 is a schematic drawing of the main part of yet another embodiment of the periodical pattern suppression processing apparatus according to the present invention, and

FIG. 17 is a graph showing the properties of the band pass filter of the one-dimensional filtering process means utilized by the periodical pattern suppression processing apparatus according to the present invention.

### DESCRIPTION OF THE PREFERRED EMBODIMENTS

Hereinafter a radiation image readout apparatus employing the first embodiment of a periodical pattern suppression processing apparatus implementing the periodical pattern suppression processing method according to the present invention will be explained in detail with reference to the attached drawings. This radiation image readout apparatus is an apparatus that scans with a laser beam a stimulable phosphor sheet on which a radiation image of a human patient has been recorded to obtain a digital image signal thereof.

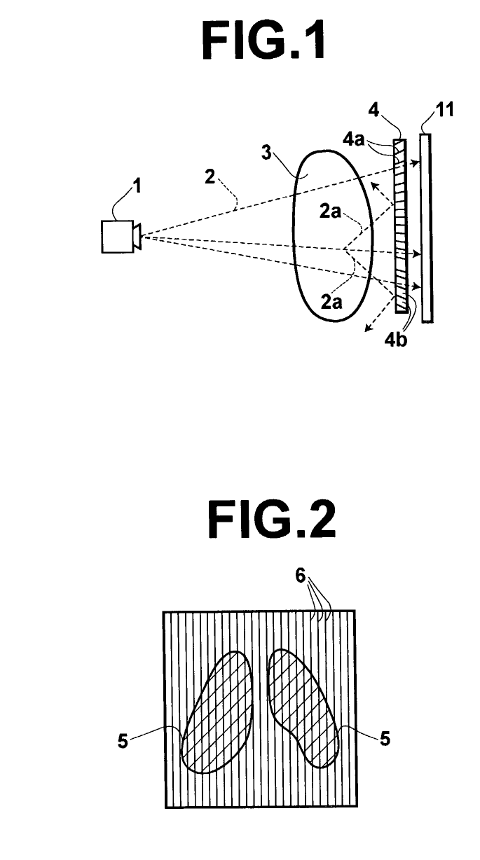

The radiation image read out by this radiation image readout means is a radiation image that has been obtained by use of a radiation image obtaining apparatus such as that shown in FIG. 1. The radiation 2 emitted from the radiation source 1 of the radiation image obtaining apparatus passes through the target subject 3 to arrive at the grid 4. The grid 4 is formed of lead grid elements 4a, which absorb radiation, and aluminum grid elements 4b, which transmit radiation, disposed alternately at a pitch of 4 elements per mm. Further, the lead grid elements 4a are provided at a slight slant corresponding to the positions thereof so as to enable the radiation 2 emitted from the radiation source 1 that passes through the aluminum grid elements 4b to enter the sheet 11 at a directly perpendicular orientation.

Accordingly, on the one hand, a portion of the radiation 2 emitted from the radiation source 1 and which has passed directly through the target subject 3 impinges on the lead grid elements 4a and is absorbed and intercepted thereby, and a portion impinges on the aluminum grid elements 4b and is transmitted thereby and projected onto the sheet 11; whereby, an image of the target subject 3 along with an image of the four elements per mm lattice pattern of the grid are cumulatively recorded thereon. On the other hand, because the dispersion radiation 2a, which has been dispersed within the target subject 3, enters the grid 4 at a diagonal with respect to the aforementioned orientation, the dispersion radiation 2a entering the aluminum grid elements 4b is also absorbed by the lead grid elements 4a within the interior of the grid or reflected from the surface of the grid 4; whereby the dispersion light does not enter the sheet 11, and as a result, a sharp radiation image containing a very small amount of dispersion radiation 2a is recorded thereon.

FIG. 2 is a drawing showing the target subject image 5 (the hatched portion) and the striped pattern grid image 6, which have been recorded on the sheet 1 by an image obtainment process utilizing the grid 4. In this manner, a radiation image in which the target subject image 5 and the grid image 6 are superposed is recorded on the sheet 11.

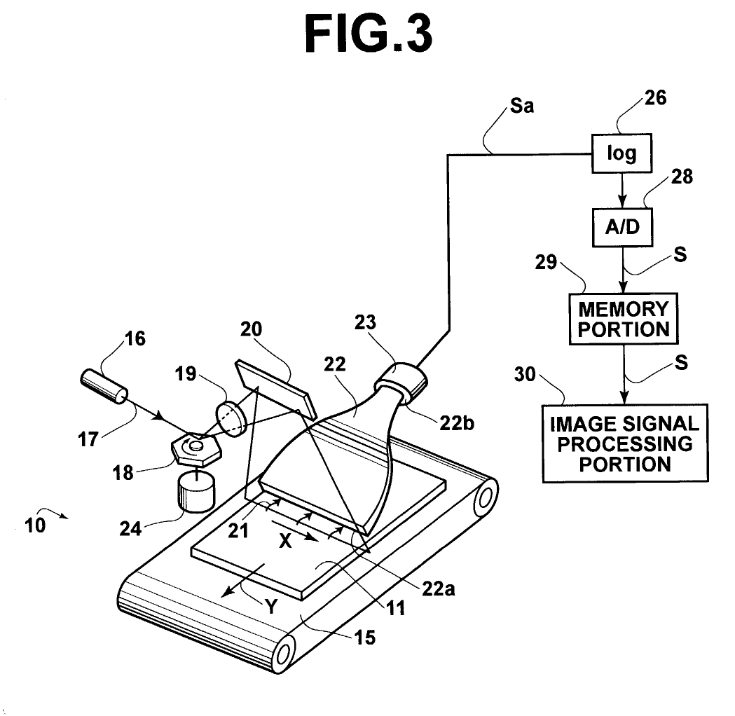

FIG. 3 is a perspective view of the radiation image readout means employing the periodical pattern suppression processing apparatus according to the current embodiment. The sheet 11, which has been set in the predetermined position of the readout portion 10, is conveyed in the direction indicated by the arrow Y (the sub-scanning direction) at a scanning pitch of ten scanning lines per mm by a sheet conveying means 15, which is an endless belt driven by a drive means (not shown), or the like. Meanwhile, after the laser beam 17 emitted from the laser light source 16 is deflected by a multifaceted rotational mirror 18 rotating at high speed, which is driven by a motor 24 in the direction indicated by the arrow, and transmitted by a focusing lens such as an fθ lens or the like, said laser beam 17 enters the sheet 11 and is scanned in the main scanning direction, which is indicated by the arrow X and is substantially perpendicular to the sub-scanning direction (indicated by the arrow Y), by the modulation of the length of the optical path by the mirror 20. Upon the irradiation of the sheet 11 by the laser beam 17, the irradiated portions thereof emit a quantity of light, which corresponds to the recorded radiation image data stored thereon, as a stimulated emission 21. The stimulated emission 21 enters the input face 22a of the light guide 22, and after being totally reflected therein and guided through said light guide 22, said stimulated emission 21 is emitted from the output face 22b of the light guide 2 and received by the photomultiplier 23, whereupon the stimulated emission 21 representing the radiation image is photoelectrically detected by the photomultiplier 23 and converted to an electric signal Sa.

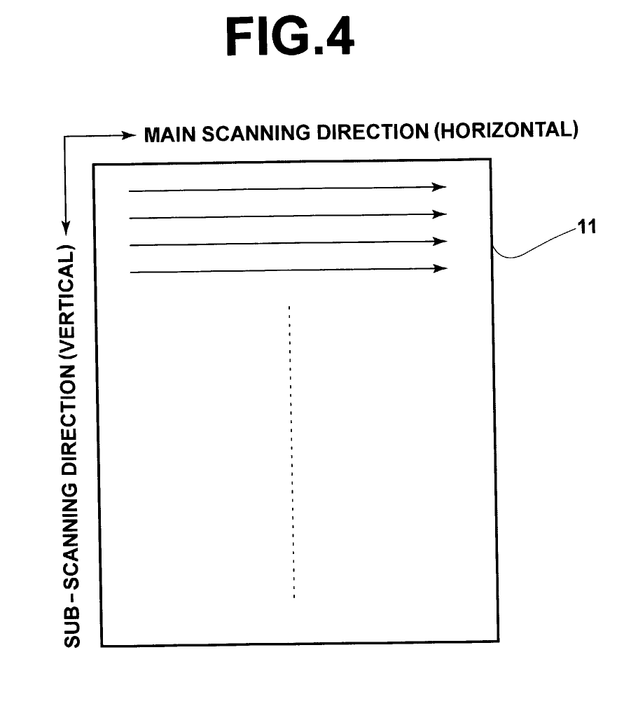

After the analog output signal Sa has been logarithmically amplified by the logarithmic amplifier 26, said amplified analog signal Sa is inputted to an A/D converter 28, sampled at a sampling interval corresponding to a spatial frequency fs=10 cycles/mm and digitized to obtain a high density digital image signal S having a high readout density. The image signal S, as shown in FIG. 4, represents the image data obtained by two-dimensionally scanning the sheet 11, which is performed by moving the sheet 11 in the sub-scanning direction (the vertical direction) while the laser is scanned over the sheet 11 in the main scanning direction (the horizontal direction). Note that the image signal S obtained in this manner includes the data related to the grid image 6 shown in FIG. 2, which is the data of the spatial frequency band of 4 cycles/mm and which is less than the highest spatial frequency (the Nyquist frequency described below) of fn=5 cycles/mm within a spatial frequency band of a desired range necessary for reproducing a favorable visible radiation image therefrom. When the radiation image data is to be observed as a visible image, the data relating to the grid image 6 is one cause that renders the visible image unclear and difficult to distinguish, and is data that must therefore be eliminated. Note that according to the current embodiment, because the data of the grid image 6 (4 cycles/mm) is digitized at a sampling interval corresponding to greater than or equal to twice the spatial frequency fs, no moire due to aliasing is generated in the grid image 6.

After the image signal S has been temporarily stored in the temporary memory portion 29, the image signal S is inputted to the image signal processing portion 30. The image signal processing portion 30 is provided with a periodical pattern suppression processing apparatus for implementing the periodical pattern suppression processing method of the present invention.

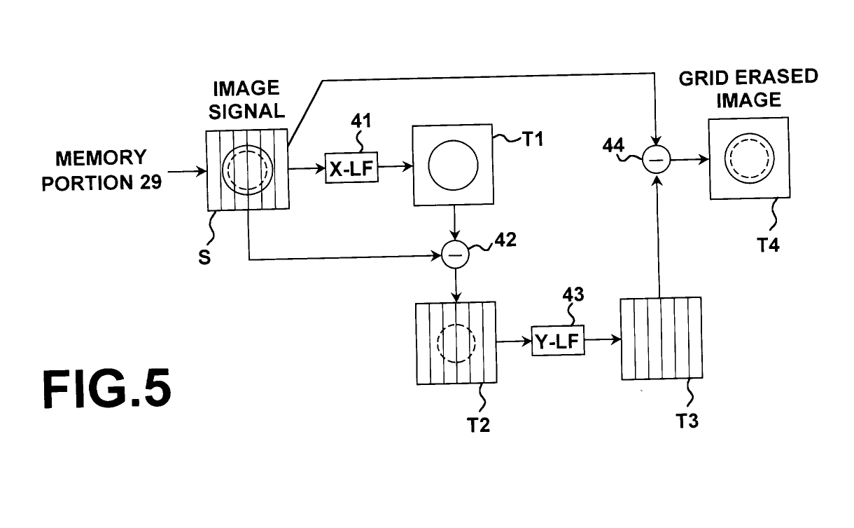

FIG. 5 is a block diagram of the main part of the periodical pattern suppression processing apparatus according to the current embodiment. As shown in FIG. 5, the periodical pattern suppression processing apparatus according to the current embodiment comprises: a first one-dimensional filtering means 41 that forms and outputs a first processed signal T1, of which the image signal component including the spatial frequency component based on the grid image has been reduced, by subjecting in the main scanning direction the image signal S read out from the memory portion 29 to a one-dimensional filtering process; a first subtraction means 42 that forms and outputs a second processed signal T2 of the image signal component by subtracting the first processed signal T1 from the image signal S; a second one-dimensional filtering means 43 that forms and outputs a grid image signal T3, in which the spatial frequency component based on the grid image has been extracted, by subjecting the second processed signal T2 to a one-dimensional filtering process in the sub-scanning direction; and a second subtraction means 44 that forms and outputs a grid erased image signal T4 by subtracting the grid image signal T3 from the image signal S.

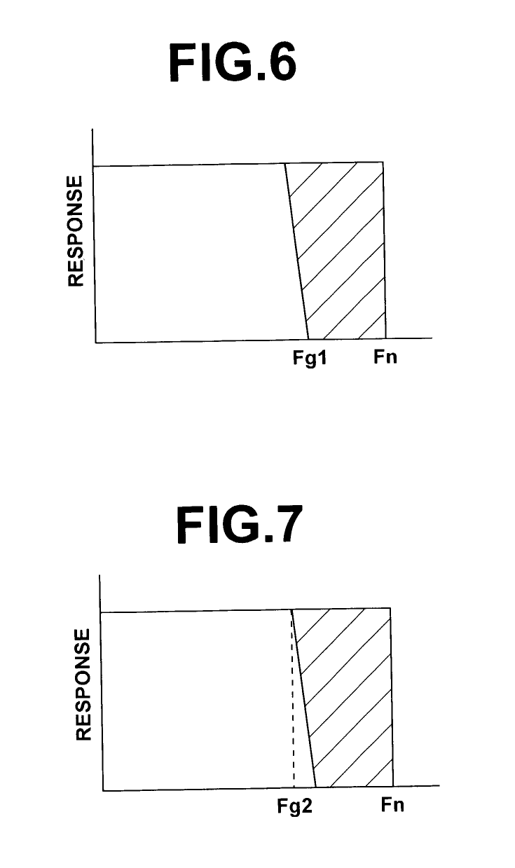

The first one-dimensional filtering process means 41 is a low pass filter having filtering properties such as those shown in FIG. 6. The second one-dimensional filtering process means 43 is a low pass filter exhibiting filtering properties such as those shown in FIG. 7. Here, the Fg1 occurring in FIG. 6 is a frequency less than even the 4 cycles/mm spatial frequency of the grid image in the main scanning direction. The Fg2 occurring in FIG. 7 is a frequency higher than the spatial frequency component (e.g., for a case in which the inclination of the grid image is in the range of ±1°: 4 cycles/mm×sin, where (1°)=0.07 cycles/mm) of the grid image in the main scanning direction. Further, the Fn is the Nyquist frequency.

Next, the operation of the periodical pattern suppression processing apparatus according to the current embodiment will be explained. Note that the bold solid line in FIG. 5 represents the low frequency component of the image signal S, and the broken line represents the high frequency component of the image signal S; the fine vertical solid lines represent the frequency component based on the grid image. The same is true of the drawings below representing other embodiments.

First, the image signal S read out from the memory portion 29 is inputted to the first one-dimensional filtering process means 41. The first one-dimensional filtering process means 41 subjects the image signal S to a one-dimensional filtering process having low pass properties in the main-scanning direction, such as those shown in FIG. 6, whereby the spatial frequency component based on the grid image and the high frequency component of the image signal S are reduced, and outputs a first processed signal T1 having the low frequency component of the image signal S. Then, the first processed signal T1 and the image signal S are inputted to the first subtraction means 42. The first subtraction means 42 forms and outputs a second processed signal T2, which has the high frequency component of the image signal S and the frequency component based on the grid image, by subtracting the first processed signal T1 from the image signal S. The second processed signal T2 outputted from the first subtraction means 42 is inputted to the second one-dimensional filtering process means 43. The second one-dimensional filtering process means 43 subjects the second processed signal T2 to a one-dimensional filtering process having low pass properties in the sub-scanning direction such as those shown in FIG. 7, whereby the spatial frequency component based on the grid image is extracted and a grid image signal T3 is formed; said grid image signal T3 is then outputted to the second subtraction means 44. The image signal S and the grid image signal T3 are inputted to the second subtraction means 44. The second subtraction means 44 subtracts the grid image signal T3 from the image signal S to form a grid erased image T4 in which the spatial frequency component based on the grid image has been suppressed, and outputs said grid erased image T4.

Next, a radiation image readout apparatus employing the second embodiment of a periodical pattern suppression processing apparatus implementing the periodical pattern suppression processing method according to the present invention will be explained in detail. The configuration and operation of this radiation image readout apparatus, and the components thereof other than the periodical pattern suppression processing apparatus of the second embodiment are the same as those of the first embodiment. Accordingly, only an explanation of the second embodiment of the periodical pattern suppression processing apparatus employed in this radiation readout apparatus will be explained.

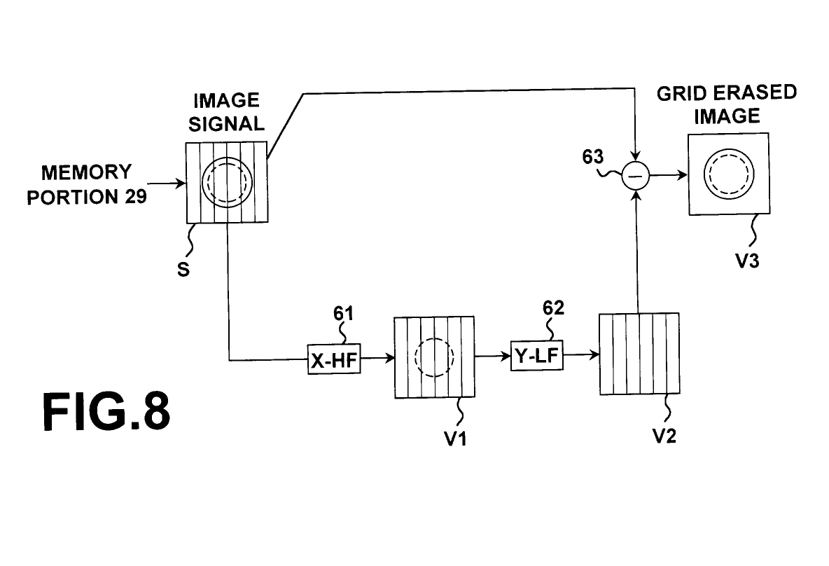

FIG. 8 is a block diagram of the main part of the periodical pattern suppression processing apparatus according to the current embodiment. As shown in FIG. 8, the periodical pattern suppression processing apparatus according to the current embodiment comprises: a first one-dimensional filtering means 61 that forms and outputs a first processed signal V1, which is an image signal component including the spatial frequency component based on the grid image, by subjecting in the main scanning direction the image signal S read out from the memory portion 29 to a one-dimensional filtering process; a second one-dimensional filtering means 62 that forms and outputs a grid image signal V2, by subjecting the first processed signal V1 to a one-dimensional filtering process in the sub-scanning direction to extract the spatial frequency component based on the grid image; and a subtraction means 63 that forms and outputs a grid erased image signal V3 by subtracting the grid image signal V2 from the image signal S.

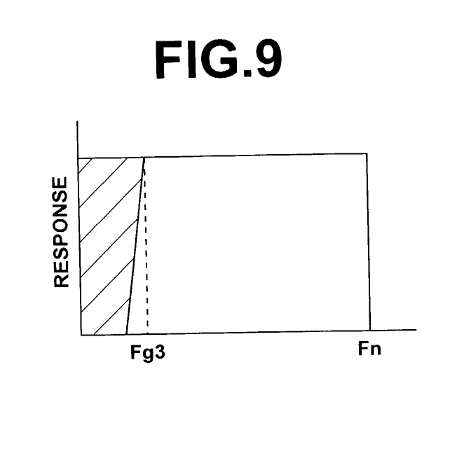

The first one-dimensional filtering process means 61 is a high pass filter having filtering properties in the main scanning direction, such as those shown in FIG. 9. Here, the Fg3 occurring in FIG. 9 is a frequency less than the 4 cycles/mm spatial frequency of the grid image in the main scanning direction. Further, the second one-dimensional filtering process means 62 is a low pass filter having the same properties as the second one-dimensional filtering process means 43 of the first embodiment shown in FIG. 7.

Next, the operation of the periodical pattern suppression processing apparatus according to the current embodiment will be explained. First, the image signal S read out from the memory portion 29 is inputted to the first one-dimensional filtering process means 61. The first one-dimensional filtering process means 61 subjects the image signal S to a one-dimensional filtering process having high pass properties in the main scanning direction, such as those shown in FIG. 9, to form a first processed signal V1 including the spatial frequency component based on the grid image and the high frequency component of the image signal S, and outputs said first processed signal V1. Then, the first processed signal V1 is inputted to the second one-dimensional filtering process means 62. The second one-dimensional filtering process means 62 subjects the first processed signal V1 to a one-dimensional filtering process having low pass properties in the sub-scanning direction, such as those shown in FIG. 7, to extract the spatial frequency component based on the grid image and form a grid image signal V2, and outputs said grid image signal V2 to the subtraction means 63. The image signal S and the grid image signal V2 are inputted to the subtraction means 63. The subtraction means 63 subtracts the grid image signal V2 from the image signal S to form a grid erased image V3 in which the spatial frequency component based on the grid image has been suppressed, and outputs said grid erased image V3.

According to the first and second embodiments of the periodical pattern suppression processing apparatus of the present invention: the spatial frequency component corresponding to a periodical pattern occurring in an image signal is extracted from the image signal by subjecting the image signal to a one-dimensional filtering process in the same direction as that of the periodical pattern and a one-dimensional filtering process in the direction perpendicular to that of the periodical pattern; and the spatial frequency component of the image signal is suppressed by subtracting from the image signal said extracted spatial frequency component; whereby it is possible to avoid deterioration of the sharpness of the image caused by signal loss due to the filtering processes and a reduction in processing time can also be expected. Further, the feedback distortion caused by the reduction process or the like occurring in a periodical pattern suppression processing method employing a conventional wavelet transform can be avoided.

Next, a radiation image readout apparatus employing the third embodiment of a periodical pattern suppression processing apparatus implementing the periodical pattern suppression processing method according to the present invention will be explained in detail. According to this radiation image readout apparatus, the configuration and operation of the components thereof other than the periodical pattern suppression processing apparatus of the third embodiment are the same as those of the first embodiment. Accordingly, only an explanation of the third embodiment of the periodical pattern suppression processing apparatus employed in this radiation readout apparatus will be explained.

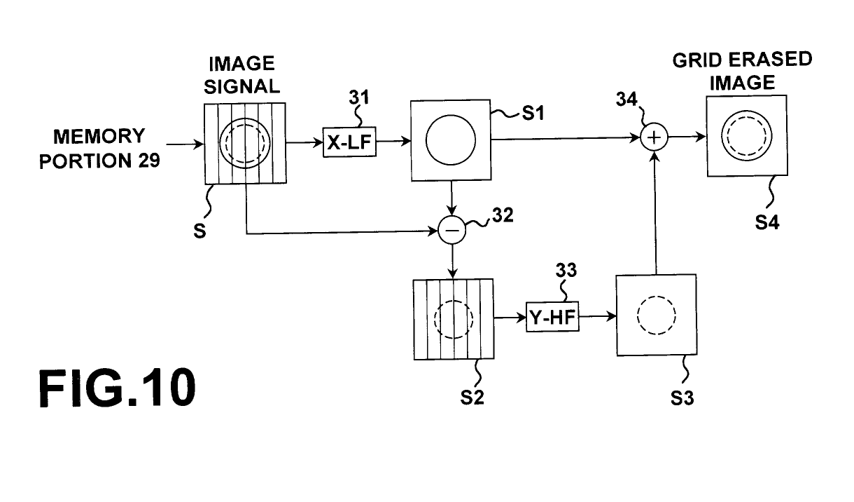

FIG. 10 is a block diagram of the main part of the periodical pattern suppression processing apparatus according to the current embodiment. As shown in FIG. 10, the periodical pattern suppression processing apparatus according to the current embodiment comprises: a first one-dimensional filtering means 61 that forms and outputs a first processed signal S1, of which the image signal component including the spatial frequency component based on the grid image has been reduced, by subjecting the image signal S read out from the memory portion 29 to a one-dimensional filtering process in the main scanning direction; a subtraction means 32 that forms and outputs a processed signal S2 of the image signal component by subtracting the first processed signal S1 from the image signal S; a second one-dimensional filtering means 33 that forms and outputs a second processed signal S3, of which the spatial frequency component thereof based on the grid image has been reduced, by subjecting the processed signal S2 to a one-dimensional filtering process in the sub-scanning direction; and an addition means 34 that forms and outputs a grid erased image signal S4 by adding the second processed signal S3 and the first processed signal S1.

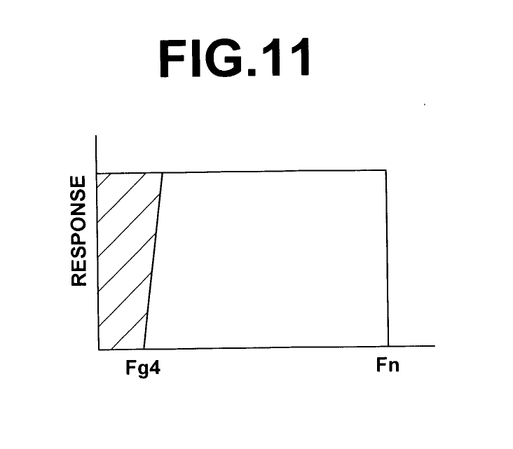

The first one-dimensional filtering process means 31 has the same properties as the first one-dimensional filtering process means 41 of the first embodiment shown in FIG. 6. Further, the second one-dimensional filtering process means 33 is a high pass filter having filtering properties such as those shown in FIG. 11. The Fg4 occurring in FIG. 11 is a frequency higher than the spatial frequency component (e.g., for a case in which the orientation of the grid image is in the range of ±1°: 4 cycles/mm×sin, where (1°)=0.07 cycles/mm) of the grid image in the sub-scanning direction.

Next, the operation of the periodical pattern suppression processing apparatus according to the current embodiment will be explained. First, the image signal S read out from the memory portion 29 is inputted to the first one-dimensional filtering process means 31. The first one-dimensional filtering process means 31 subjects the image signal S to a one-dimensional filtering process having low pass properties in the main scanning direction, such as those shown in FIG. 6, whereby the spatial frequency component based on the grid image and the high frequency component of the image signal S are reduced, to form a first processed signal S1 including the low frequency component of the image signal S, and outputs said first processed signal S1. Then, the first processed signal S1 and the image signal S are inputted to the subtraction means 32. The subtraction means 32 forms and outputs a processed signal S2, which has the high frequency component of the image signal S and the frequency component based on the grid image, by subtracting the first processed signal S1 from the image signal S. The processed signal S2 outputted from the subtraction means 32 is inputted to the second one-dimensional filtering process means 33. The second one-dimensional filtering process means 33 subjects the processed signal S2 to a one-dimensional filtering process having high pass properties in the sub-scanning direction, such as those shown in FIG. 11, to form a second processed signal S3 of which the spatial frequency component thereof based on the grid image is reduced and which includes the high frequency component of the image signal S, and outputs said grid image signal S3. The first processed signal S1 and the second processed signal S3 are inputted to the addition means 34. The addition means 34 adds the first processed signal S1, which has the low frequency component of the image signal S, and the second processed signal S3, which has the high frequency component of the image signal S, to form a grid erased image S4 in which the spatial frequency component based on the grid image has been suppressed, and outputs said grid erased image S4.

Next, a radiation image readout apparatus employing the fourth embodiment of a periodical pattern suppression processing apparatus implementing the periodical pattern suppression processing method according to the present invention will be explained in detail. According to this radiation image readout apparatus, the configuration and operation of the components thereof other than the periodical pattern suppression processing apparatus of the fourth embodiment are the same as those of the first embodiment. Accordingly, only an explanation of the fourth embodiment of the periodical pattern suppression processing apparatus employed in this radiation readout apparatus will be explained.

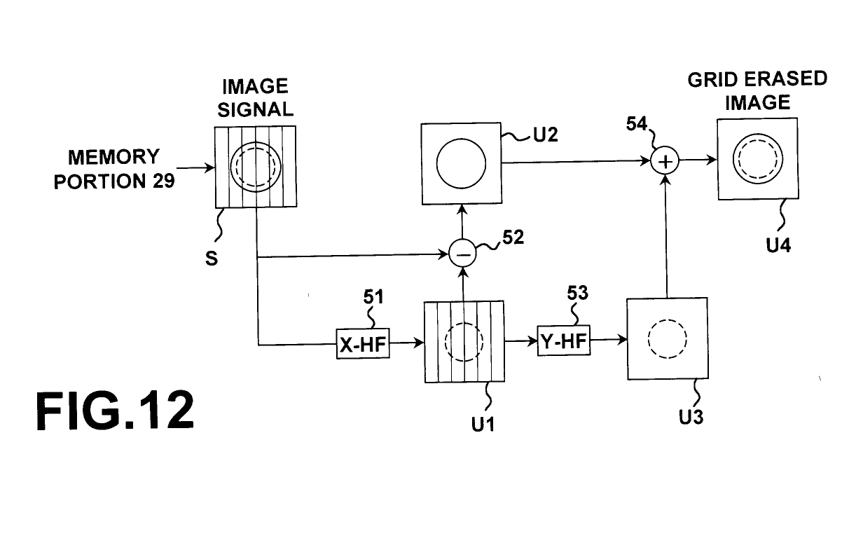

FIG. 12 is a block diagram of the main part of the periodical pattern suppression processing apparatus according to the current embodiment. As shown in FIG. 12, the signal processing portion 50 comprises: a first one-dimensional filtering means 51 that forms and outputs a processed signal U1, which is an image signal component including the spatial frequency component based on the grid image, by subjecting in the main scanning direction the image signal S read out from the memory portion 29 to a one-dimensional filtering process; a subtraction means 52 that forms and outputs a first processed signal U2 by subtracting the processed signal U1 from the image data S; a second one-dimensional filtering means 53 that forms and outputs a second processed signal U3, of which the spatial frequency thereof based on the grid image has been reduced, by subjecting the processed signal U1 to a one-dimensional filtering process in the sub-scanning direction; and an addition means 54 that forms and outputs a grid erased image signal U4 by adding the second processed signal U3 to the first processed signal U2.

The first one-dimensional filtering process means 51 has the same filtering properties as the first one-dimensional filtering process means 61 of the second embodiment shown in FIG. 9. Further, the second one-dimensional filtering process means 53 has the same properties as the second one-dimensional filtering process means 33 of the third embodiment shown in FIG. 11.

Next, the operation of the periodical pattern suppression processing apparatus according to the current embodiment will be explained. First, the image signal S read out from the memory portion 29 is inputted to the first one-dimensional filtering process means 51. The first one-dimensional filtering process means 51 subjects the image signal S to a one-dimensional filtering process having high pass properties in the main scanning direction, such as those shown in FIG. 9, to form a processed signal U1 including the spatial frequency component based on the grid image and the high frequency component of the image signal S, and outputs said processed signal U1. Then, the processed signal U1 and the image signal S are inputted to the subtraction means 52. The subtraction means 52 subtracts the processed signal U1 from the image signal S to form a first processed signal U2 of the low frequency component of the image signal S, and outputs said first processed signal U2. Meanwhile, the processed signal U1 outputted from the first one-dimensional filtering process means 51 is inputted to the second one-dimensional filtering process means 53. The second one-dimensional filtering process means 53 subjects the processed signal U1 to a one-dimensional filtering process having high pass properties in the sub-scanning direction, such as those shown in FIG. 11, to form a second processed signal U3 of which the spatial frequency component based on the grid image is reduced and which includes the high frequency component of the image signal S, and outputs said grid image signal S3 to the addition means 54. The first processed signal U2 and the second processed signal U3 are inputted to the addition means 54. The addition means 54 adds the first processed signal U2, which has the low frequency component of the image signal S, and the second processed signal U3, which has the high frequency component of the image signal S, to form a grid erased image U4 in which the spatial frequency component based on the grid image has been suppressed, and outputs said grid erased image U4.

According to the third and fourth embodiments of the periodical pattern suppression processing apparatus of the present invention: the spatial frequency component corresponding to a periodical pattern occurring in an image signal is extracted from the image signal by subjecting the image signal to either of a one-dimensional filtering process in the same direction as that of the periodical pattern or a one-dimensional filtering process in the direction perpendicular to that of the periodical pattern; a first processed signal of which the spatial component corresponding to the periodical pattern has been reduced is formed based on the thus processed image signal component; the image signal is subjected to both a one-dimensional filtering process in the same direction as that of the periodical pattern and a one-dimensional filtering process in the direction perpendicular to that of the periodical pattern, and a second processed signal of which the spatial frequency component corresponding to the periodical pattern has been reduced is formed based on the image signal component that has been thus subjected to both said one-dimensional filtering processes; and the spatial frequency component corresponding to the periodical pattern occurring in the image signal is suppressed by adding the first and second processed signals; whereby it is possible to avoid deterioration of the sharpness of the image caused by signal loss due to the filtering process and a reduction in processing time can also be expected, as in the case of the first and second embodiments.

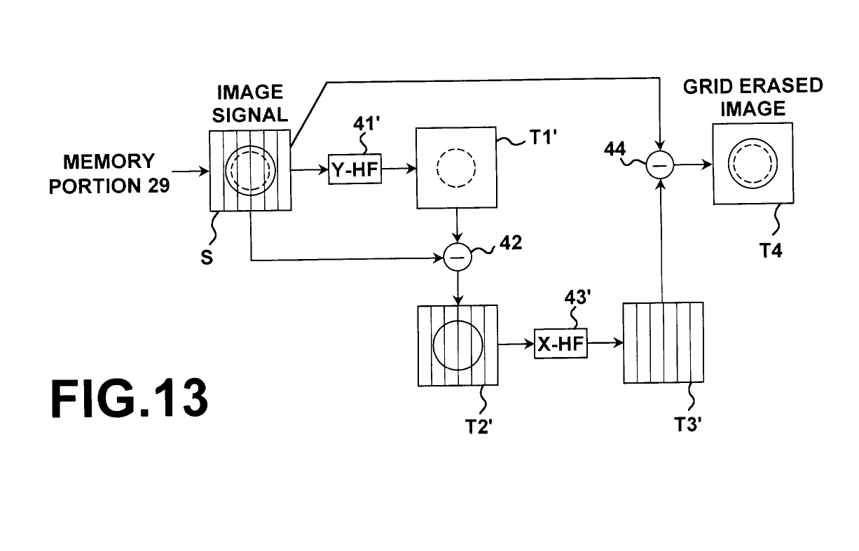

Further, regarding the first embodiment: the first one-dimensional filtering process means 41 having low pass properties in the main scanning direction such as those shown in FIG. 13 can be made to have high pass properties in the sub-scanning direction; and the second one-dimensional filtering process means 43 can be made to have high pass properties in the main scanning direction. At this time, the filtering properties of the first one-dimensional filtering process means 41′ are high pass properties such as those shown in FIG. 11, and the filtering properties of the second one-dimensional filtering process means 43′ are high pass properties such as those shown in FIG. 9.

In this case, the image signal S read out from the memory portion 29 is inputted to the first one-dimensional filtering process means 41′. The first one-dimensional filtering process means 41′ subjects the image signal S to a one-dimensional filtering process having high pass properties in the sub-scanning direction, such as those shown in FIG. 11, and outputs a first processed signal T1′ having the high frequency component of the image signal S. Then, the first processed signal T1′ and the image signal S are inputted to the first subtraction means 42. The first subtraction means 42 forms and outputs a second processed signal T2′, which has the low frequency component of the image signal S and the frequency component based on the grid image, by subtracting the first processed signal T1′ from the image signal S. The second processed signal T2′ outputted from the first subtraction means 42 is inputted to the second one-dimensional filtering process means 43′. The second one-dimensional filtering process means 43′ subjects the second processed signal T2′ to a one-dimensional filtering process having high pass properties in the main scanning direction such as those shown in FIG. 9, whereby the spatial frequency component based on the grid image is extracted and a grid image signal T3′ is formed; said grid image signal T3′ is then outputted to the second subtraction means 44. The image signal S and the grid image signal T3′ are inputted to the second subtraction means 44. The second subtraction means 44 subtracts the grid image signal T3′ from the image signal S to form a grid erased image T4 in which the spatial frequency component based on the grid image has been suppressed, and then outputs the grid erased image T4.

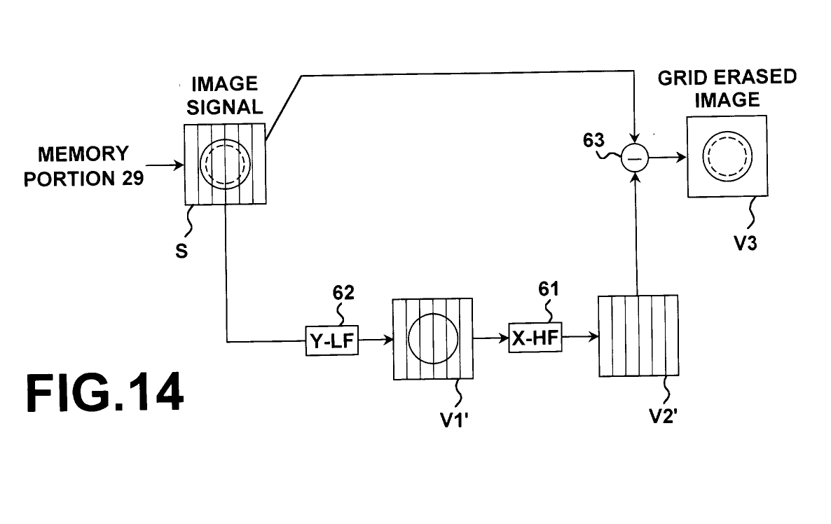

Further, regarding the second embodiment, as shown in FIG. 14, a configuration wherein the first one-dimensional filtering process means 61 and the second one-dimensional filtering process means 62 have been switched is also possible. In this case, the image signal S read out from the memory portion 29 is inputted to the second one-dimensional filtering process means 62. The second one-dimensional filtering process means 62 subjects the image signal S to a one-dimensional filtering process having low pass properties in the sub-scanning direction, such as those shown in FIG. 7, to form a first processed signal V1′ having the spatial frequency component based on the grid image and the low frequency component of the image signal S, and outputs said first processed signal V1′. Then, the first processed signal V1′ is inputted to the first one-dimensional filtering process means 61. The first one-dimensional filtering process means 61 subjects the first processed signal V1′ to a one-dimensional filtering process having high pass properties in the main scanning direction, such as those shown in FIG. 9, to extract the spatial frequency component based on the grid image and form a grid image signal V2′, and outputs said grid image signal V2′ to the subtraction means 63. The image signal S and the grid image signal V2′ are inputted to the subtraction means 63. The subtraction means 63 subtracts the grid image signal V2 from the image signal S to form a grid erased image V3 in which the spatial frequency component based on the grid image has been suppressed, and outputs the grid erased image V3.

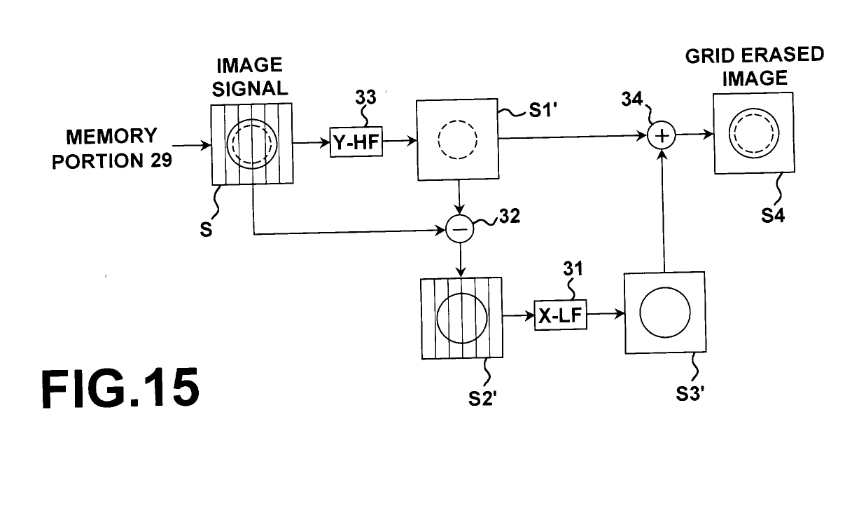

Further, regarding the third embodiment, as shown in FIG. 15, a configuration wherein the first one-dimensional filtering process means 31 and the second one-dimensional filtering process means 33 have been switched is also possible. In this case, the image signal S read out from the memory portion 29 is inputted to the second one-dimensional filtering process means 33. The second one-dimensional filtering process means 33 subjects the image signal S to a one-dimensional filtering process having high pass properties in the sub-scanning direction, such as those shown in FIG. 11, to form a first processed signal S1′ having the high frequency component of the image signal S, and outputs said first processed signal S1. Then, the first processed signal S1′ and the image signal S are inputted to the subtraction means 32. The subtraction means 32 forms and outputs a processed signal S2′ having the low frequency component of the image signal S and the frequency component based on the grid image, by subtracting the first processed signal S1 from the image signal S. The processed signal S2′ outputted from the subtraction means 32 is inputted to the first one-dimensional filtering process means 31. The first one-dimensional filtering process means 31 subjects the processed signal S2′ to a one-dimensional filtering process having low pass properties in the main scanning direction, such as those shown in FIG. 6, whereby the spatial frequency component based on the grid image is reduced, to form a second processed signal S3′ having the low frequency component of the original image signal S, and outputs said grid image signal S3′. The first processed signal S′ and the second processed signal S3′ are inputted to the addition means 34. The addition means 34 adds the first processed signal S1′, which has the high frequency component of the image signal S, and the second processed signal S3′, which has the low frequency component of the image signal S, to form a grid erased image S4 in which the spatial frequency component based on the grid image has been suppressed, and then outputs the grid erased image S4.

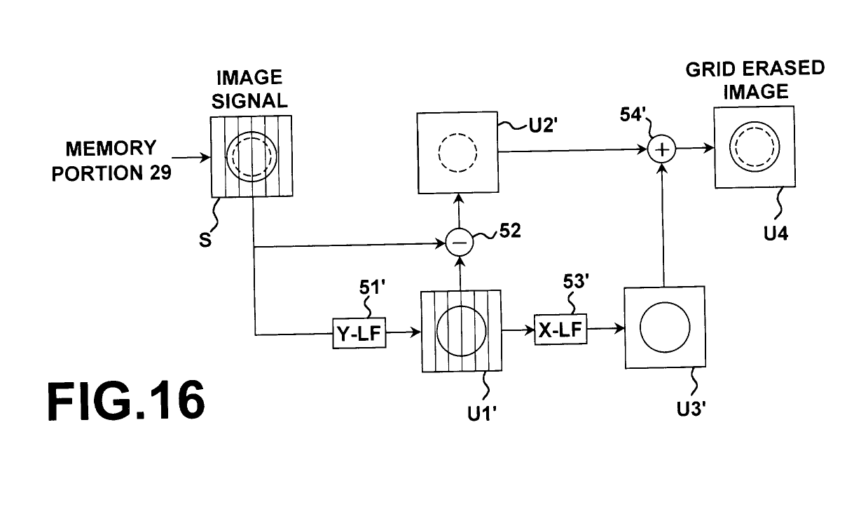

Further, regarding the fourth embodiment, as shown in FIG. 16, a configuration wherein the first one-dimensional filtering process means 51, which is a high pass filter operational in the main scanning direction, can be made to be a low pass filter operational in the sub-scanning direction, and the second one-dimensional filtering process means 53, which is a high pass filter operational in the sub-scanning direction, can be made to be a low pass filter operational in the main scanning direction. At this time, the filtering properties of the first one-dimensional filtering process means 51′ are high pass properties such as those shown in FIG. 7, and the filtering properties of the second one-dimensional filtering process means 53′ are low pass properties such as those shown in FIG. 6.

In this case, the image signal S read out from the memory portion 29 is inputted to the first one-dimensional filtering process means 51′. The first one-dimensional filtering process means 51′ subjects the image signal S to a one-dimensional filtering process having low pass properties in the sub-scanning direction, such as those shown in FIG. 7, to form a processed signal U1′ including the spatial frequency component based on the grid image and the low frequency component of the image signal S, and outputs said processed signal U1′. Then, the processed signal U1′ and the image signal S are inputted to the subtraction means 52. The subtraction means 52 subtracts the processed signal U1′ from the image signal S to form a first processed signal U2′ having the high frequency component of the image signal S, and outputs said first processed signal U2′. Meanwhile, the processed signal U1′ outputted from the first one-dimensional filtering process means 51′ is inputted to the second one-dimensional filtering process means 53′. The second one-dimensional filtering process means 53′ subjects the processed signal U1′ to a one-dimensional filtering process having low pass properties in the main scanning direction, such as those shown in FIG. 6, to form a second processed signal U3′ of which the spatial frequency component based on the grid image is reduced, and outputs said grid image signal S3 to the addition means 54. The first processed signal U2′ and the second processed signal U3 are inputted to the addition means 54. The addition means 54 adds the first processed signal U2′, which has the high frequency component of the image signal S, and the second processed signal U3, which has the low frequency component of the image signal S, to form a grid erased image U4 in which the spatial frequency component based on the grid image has been suppressed, and then outputs the grid erased image S4.

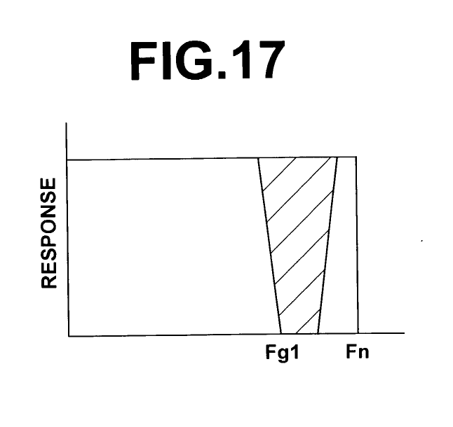

Further, regarding the periodical pattern suppression processing apparatus of each of the embodiments described above, although a high pass filter or a low pass filter has been employed as the first and the second one-dimensional filtering process means, for the low pass filter shown in FIG. 6, for example, a band pass filter such as that shown in FIG. 17 may be employed instead. A band pass filter may be employed in the same manner for the other low pass filters and the high pass filters as well. If a band pass filter is employed as described above, an even further improvement in image quality can be expected.

Still further, regarding the periodical pattern suppression processing apparatus of each of the embodiments described above, a periodical pattern detecting means for detecting the spatial frequency component corresponding to a periodical pattern occurring within an image signal can be provided, and the suppression process of suppressing the spatial frequency component based on a grid or other such image performed only when the spatial frequency component of the grid or other such image has been detected by the detecting means. According to the detecting means, more specifically, a portion of the original image signal (e.g. one line of pixels in each of the main and sub-scanning direction) can be subjected to a Fourier transform in the main and sub-scanning directions to convert the frequencies thereof, and the spatial frequency based on the grid image can be detected from the frequency conversion signal, for example. By providing a detecting means such as that described above, it becomes possible to avoid the performance of unnecessary processing in a radiation image readout apparatus that reads out radiation images for which a grid has been used in the image obtainment process and cases in which a grid has not been used, for example.

Even further still, according to the periodical pattern suppression processing apparatus of each of the embodiments described above, a direction recognition means for discerning the direction of a periodical pattern occurring in an image signal, and a filtering direction setting means for setting, based on the direction discerned by the direction recognition means, the direction of the one-dimensional filtering process of the first and second one-dimensional filtering process means, can be provided. According to the direction recognition means, more specifically, a portion of the original image signal (e.g. one line of pixels in each of the main and sub-scanning direction) can be subjected to a Fourier transform in the main and sub-scanning directions to convert the frequencies thereof, the peak electrical value of the frequency conversion signal of the spatial frequency component based on the grid image in each of the main and sub-scanning directions can be obtained, and the direction of the grid image detected by performing a comparison of the obtained values, for example. By providing a detecting means and a filtering direction setting means such as those described above, an appropriate suppression processing can be performed without regard to the direction of the grid employed in the obtainment of the image.

What is claimed is:

1. A periodical pattern suppression processing method of suppressing the spatial frequency component corresponding to a periodical pattern occurring in an image signal, comprising the steps of:
extracting from the image signal the spatial frequency component corresponding to a periodical pattern included therein by subjecting the image signal to a one-dimensional filtering process in the same direction as that of the periodical pattern and in to another one-dimensional filtering process in the direction perpendicular to that of the periodical pattern, and
suppressing the spatial frequency component occurring in the image signal by subtracting from the image signal said extracted spatial frequency component.

2. A periodical pattern suppression processing method as defined in claim 1, wherein the extraction of the spatial frequency component corresponding to the periodical pattern is performed by:
forming a first processed signal, of which the image signal component including the spatial frequency component corresponding to the periodical pattern is reduced, by subjecting the image signal to one of the one-dimensional filtering processes,
forming a second processed signal by subtracting the first processed signal from the image signal, and
subjecting the second processed signal to the other of the one-dimensional filtering processes.

3. A periodical pattern suppression processing method as defined in claim 1, wherein the extraction of the spatial frequency component corresponding to the periodical pattern is performed by:
forming a first processed signal, which includes the spatial frequency component corresponding to the periodical pattern, by subjecting the image signal to one of the one-dimensional filtering processes, and
subjecting the first processed signal to the other of the one-dimensional filtering processes.

4. A periodical pattern suppression processing method of suppressing the spatial frequency component corresponding to a periodical pattern occurring in an image signal, comprising the steps of:
subjecting the image signal to a process including either of a one-dimensional filtering process performed in the same direction as that of the periodical pattern or a one-dimensional filtering process performed in the direction perpendicular to that of the periodical pattern,
forming, based on the thus processed image signal component, a first processed signal of which the spatial component corresponding to the periodical pattern has been reduced,
subjecting the image signal to a process including the other of the one-dimensional filtering process and forming, based on the thus processed image signal component, a second processed signal of which the spatial frequency component corresponding to the periodical pattern is reduced and which has a spatial frequency component different from that of the first processed signal, and
suppressing the spatial frequency component corresponding to the periodical pattern occurring in the image signal by adding the first and second processed signals.

5. A periodical pattern suppression processing method as defined in claim 4, wherein
the formation of the second processed signal can be performed by subtracting from the image signal the first processed signal, which has been formed by utilizing either of the one-dimensional filtering process performed in the same direction as that of a periodical pattern present in the image signal or the one-dimensional filtering process in the direction perpendicular thereto, and
subjecting the resultant image signal to the other one-dimensional filtering process.

6. A periodical pattern suppression processing method as defined in claim 4, wherein
the formation of the first processed signal can be performed by subtracting from the image signal the image signal component formed by utilizing either of the one-dimensional filtering process performed in the same direction as that of a periodical pattern present in the image signal or the one-dimensional filtering process in the direction perpendicular thereto.

7. A periodical pattern suppression processing method as defined in claim 1, wherein
a detection process is performed to detect the presence of the spatial frequency component corresponding to the periodical pattern in the image signal, and
the suppression processing is performed only when a positive result is obtained by the detection process.

8. A periodical pattern suppression processing method as defined in claim 1, wherein
the direction of the periodical pattern occurring in the image signal is discerned, and
the directions of the one-dimensional filtering processes are set based upon said discerned direction.

9. A periodical pattern suppression processing method as defined in claim 1, wherein
the periodical pattern is the image of the stationary grid occurring in an image that has been obtained utilizing said stationary grid.

10. A periodical pattern suppression processing apparatus for suppressing the spatial frequency component corresponding to a periodical pattern occurring in an image signal, comprising:
a first one-dimensional filtering process means for subjecting the image signal to a one-dimensional filtering process in the same direction as that of the periodical pattern,
a second one-dimensional filtering process means for subjecting the image signal to a one-dimensional filtering process in the direction perpendicular to that of the periodical pattern, and
a subtraction processing means for subtracting from the image signal the spatial frequency component, which corresponds to the periodical pattern, extracted by the one-dimensional filtering processes of the first and second one-dimensional filtering process means.

11. A periodical pattern suppression processing apparatus for suppressing the spatial frequency component corresponding to a periodical pattern occurring in an image signal, comprising:
a first one-dimensional filtering process means for subjecting the image signal to a one-dimensional filtering process in the same direction as that of the periodical pattern,
a second one-dimensional filtering process means for subjecting the image signal to a one-dimensional filtering process in the direction perpendicular to that of the periodical pattern, and
an addition processing means for adding a first processed signal based on the image signal component obtained by the subjection of the image signal to a process including the one-dimensional filtering process of either the first or the second one-dimensional filtering process means and of which the spatial frequency component corresponding to the periodical pattern has been reduced, and a second processed signal based on the image signal component obtained by the subjection of the image signal to a process including the one-dimensional filtering process of the other of the one-dimensional filtering process means, which has a spatial frequency component different from that of the first processed signal and of which the spatial frequency component corresponding to the periodical pattern has been reduced.

12. A periodical pattern suppression processing apparatus as defined in claim 10, further comprising
a periodical pattern detecting means for detecting the spatial frequency component corresponding to the periodical pattern occurring within the image signal.

13. A periodical pattern suppression processing apparatus as defined in claim 10, further comprising
a direction recognition means for discerning the direction of a periodical pattern occurring in an image signal, and
a filtering direction setting means for setting, based on the direction discerned by said direction recognition means, the direction of the one-dimensional filtering process.

14. A periodical pattern suppression processing apparatus as defined in claim 10, wherein
the periodical pattern is the image of the stationary grid occurring in an image that has been obtained utilizing said stationary grid.
